(19) United States
(12) Patent Application Publication
(10) Pub. No.: US 2008/0085423 A1
(43) Pub. Date: Apr. 10, 2008

(54) PLASMA DISPLAY PANEL, A METHOD FOR MANUFACTURING A PLASMA DISPLAY PANEL, AND RELATED TECHNOLOGIES

(75) Inventor: Tae In KWON, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/870,219

(22) Filed: Oct. 10, 2007

(30) Foreign Application Priority Data
Oct. 10, 2006 (KR) 10-2006-0098326

(51) Int. Cl. B32B 9/04; B23P 17/04

(52) U.S. Cl. 428/702; 29/592

(57) ABSTRACT

A plasma display panel includes a substrate with electrodes. A dielectric layer is disposed over the substrate and covers the electrodes. The dielectric layer includes 10 to 60 mol % of Bi₂O₃, 5 to 40% of CuO, and 15 to 40 mol % of B₂O₃.

This application claims priority from Korean Patent Application No. 10-2006-0098326, filed Oct. 10, 2006, in the Korean Intellectual Property Office, the entirety of which is incorporated by reference herein.

### BACKGROUND

1. Field

This disclosure relates to a plasma display panel and a method for manufacturing the plasma display panel.

2. Discussion of the Related Art

The advent of the multimedia age has brought a demand for large display devices capable of finely rendering colors that approximate natural colors. However, current cathode ray tubes (CRTs) may be limited in realizing large screens of 40 inches or more. For this reason, liquid crystal displays (LCDs), plasma display panels (PDPs), and projection televisions (TVs) are being rapidly developed so that they can be used for high-quality images.

A PDP is an electronic device that displays an image using a plasma discharge. By applying a predetermined voltage to electrodes arranged in a discharge space of the PDP, a plasma discharge is generated between the electrodes. A phosphor layer formed into a predetermined pattern by vacuum ultraviolet (VUV), which is generated during the plasma discharge, is excited to form an image.

The PDP has dielectric layers formed on an upper and lower panel. To form a dielectric layer on the upper panel, 20 to 30 mol % of an organic binder is mixed to a borosilicate glass powder with a particle size of 1 to 2 μm containing about 60 mol % or more Pb (lead) such that the mixture has a viscosity of about 40,000 cps (centipoises). Then, using a screen printing method, the mixture is applied onto an overall surface of an upper substrate formed with sustain electrode pairs. The mixture is cured at a temperature of 550 to 580° C. Such an upper dielectric layer has a permittivity in the range of 14 to 16, and a light transmittance to visible light of about 70% at a peak wavelength of 550 nm.

In order to form a lower dielectric layer and a barrier rib, first, several tens mol % of an oxide fine powder such as TiO₂ or Al₂O₃ is mixed to a parent glass powder containing about 60 mol % or more PbO (lead oxide). Then, an organic solvent is added to the mixture to prepare a paste having a viscosity of about 40,000 cps. After preparing the paste as in the above, the paste is applied onto an overall surface of a lower substrate, formed with an address electrode, with a thickness of 20 to 25 μm using a screen printing method. The paste is cured at a temperature of 550 to 600° C. to form the lower dielectric layer. Thereafter, the paste is again applied onto the lower dielectric layer with a thickness of 12 to 200 μm. And a barrier rib pattern is formed by screen printing, sand blasting, or molding the paste. Then, the paste is cured to form the barrier rib. Here, the oxide fine powder improves a reflection characteristic, controls a permittivity, and ensures an impact resistance.

The PDP makes use of a high strain point glass (e.g., PD-200) as front and back substrates. However, the use of a soda-lime glass has been positively considered, because the soda-lime glass is cost-effective by about ⅙ compared with PD-200. Thus, the soda-lime glass is advantageous in unit cost. Therefore, in order to improve the cost-competitiveness of the overall PDP, research on the use of the soda-lime glass substrate has been conducted vigorously.

For the dielectric layer formed on the front substrate, a material containing Pb is used. However, given problems such as environmental pollution due to using Pb, restrictions on the material containing Pb are being intensified. Therefore, research on a composition capable of substituting the Pb-containing material as the dielectric composition for the plasma display panel has been conducted vigorously.

Bismuth (Bi)-based dielectric compositions and zinc (Zn)-based dielectric compositions are widely known. The Bi-based dielectric composition also causes environmental pollution, and unit cost of the composition is high. On the other hand, the Zn-based dielectric composition is free from the environmental pollution, and also has a cost merit of about 50% compared with the Bi-based dielectric composition.

However, since the Zn-based dielectric composition has a high glass transition temperature (Tg), the Zn-based dielectric composition does not meet with the curing conditions of the dielectric composition when using the soda-lime glass. That is, the soda-lime glass to be used mainly as a substrate for a PDP due to the unit cost merit undergoes thermal deformation when heated to a temperature of about 550° C. or higher. It is preferable, therefore, that the temperature does not exceed 550° C. The Zn-based dielectric composition, however, has a glass transition temperature exceeding 550° C. Thus, a temperature required in curing, which is performed essentially for forming the dielectric layer, higher than 550° C. is demanded. As a result, thermal deformation of the soda-lime glass occurs during curing due to such a high curing temperature.

Additionally, since the thermal expansion coefficient of the soda-lime glass is higher than the conventional PD-200 glass, distortion may occur due to the difference in the thermal expansion coefficient between the soda-lime glass and the dielectric layer, in consideration of the heat generation characteristic of the plasma display panel, unless the dielectric composition also has a high thermal expansion coefficient.

### SUMMARY

In one general aspect, a plasma display panel comprises a substrate having sustain electrodes disposed on a surface of the substrate. The plasma display panel includes a dielectric layer disposed over the substrate and covering the sustain electrodes, the dielectric layer comprising 10 to 60 mol % of Bi₂O₃, 5 to 40 mol % of CuO, and 15 to 40 mol % of B₂O₃.

Implementations may include one or more of the following features. For example, the dielectric layer may further comprise one of 0 to 10 mol % SiO₂, 0 to 30 mol % of ZnO, and 0 to 35 mol % of BaO. The dielectric layer may further comprise one of 0 to 10 mol % of MgO, 0 to 10 mol % of SrO, and 0 to 10 mol % of CaO. The dielectric layer may further comprises one of 0 to 10 mol % of Al₂O₃ and 0 to 10 mol % of La₂O₃. In some implementations, the dielectric layer may further comprise 0 to 10 mol % of R₂O. The R₂O may include at least one of Li₂O, Na₂O and K₂O.

In another general aspect, a plasma display panel comprises a first substrate including at least one sustain electrode pair extending in a first direction. The plasma display panel comprises a first dielectric layer disposed over the sustain electrode pair, and a protect layer disposed over the first dielectric layer. The plasma display panel comprises a second substrate including at least one address electrode, the at least one address electrode extending in a direction perpendicular to the first direction. The plasma display panel includes a second dielectric layer disposed on the second substrate. The plasma display panel includes a third dielectric layer interposed between the first substrate and the second substrate. At least one of the first, second and third dielectric layers comprises 10 to 60 mol % of Bi₂O₃, 5 to 40% of CuO, and 15 to 40 mol % of B₂O₃.

Implementations may include one or more of the following features. For example, at least one of the first, second and third dielectric layers may further comprise one of 0 to 10 mol % SiO₂, 0 to 30 mol % of ZnO, and 0 to 35 mol % of BaO.

At least one of the first, second and third dielectric layers may further comprise one of 0 to 10 mol % of MgO, 0 to 10 mol % of SrO, and 0 to 10 mol % of CaO. At least one of the first, second and third dielectric layers may further comprise one of 0 to 10 mol % of Al₂O₃ and 0 to 10 mol % of La₂O₃.

In some implementations, at least one of the first, second and third dielectric layers further comprises 0 to 10 mol % of R₂O. The R₂O may include at least one of Li₂O, Na₂O and K₂O.

In some implementations, at least one of the first and second substrates may include a soda-lime glass substrate.

In another general aspect, a plasma display panel comprises a substrate having sustain electrodes disposed on a surface of the substrate. The plasma display panel further comprises a dielectric layer disposed over the substrate and covering the sustain electrodes. The dielectric layer comprises a first mol % of Bi₂O₃, a second mol % of CuO, and a third mol % of B₂O₃. The first mol % is greater than the second mol %. The first mol % is greater than or equal to the third mol %. The third mol % is greater than the second mol %.

In some implementations, the dielectric layer farther comprises: one of 0 to 10 mol % SiO₂, 0 to 30 mol % of ZnO, and 0 to 35 mol % of BaO; one of 0 to 10 mol % of MgO, 0 to 10 mol % of SrO, and 0 to 10 mol % of CaO; one of 0 to 10 mol % of Al₂O₃ and 0 to 10 mol % of La₂O₃; and 0 to 10 mol % of R₂O.

In another general aspect, a method for manufacturing a plasma display panel involves forming a first dielectric layer over a first display substrate, the first display substrate having display electrodes extending in a first direction. The first dielectric layer covers the display electrodes. The first dielectric layer comprises 10 to 60 mol % of Bi₂O₃, 5 to 40% of CuO, and 15 to 40 mol % of B₂O₃. The method involves forming a second dielectric layer over a back substrate to cover address electrodes on the back substrate. The address electrodes extend in a direction perpendicular to the first direction. The method involves assembling the display substrate and the back substrate, with barrier ribs interposed between the display substrate and the back substrate, and with regions where the address electrodes intersect the display electrodes defining discharge cells.

Implementations may include one or more of the following features. For example, forming the first dielectric layer may involve: preparing a dielectric material comprising 10 to 60 mol % of Bi₂O₃, 5 to 40% of CuO, and 15 to 40 mol % of B₂O₃; coating the dielectric material using one of a screen printing method, a dispensing method, and an inkjet method; and drying and curing the dielectric material.

The curing may be performed at a temperature of 480° C. or lower. Preparing the dielectric material may involve: preparing a mixture of 10 to 60 mol % of Bi₂O₃, 5 to 40% of CuO, and 15 to 40 mol % of B₂O₃; melting and cooling the mixture; and forming a glass powder by grinding the mixture. The dielectric material may comprise 70 to 90 wt % of the glass powder and 10 to 30 wt % of vehicle.

In some implementations, the first dielectric layer may further comprise a substance selected from the group consisting of cordierite (2MgO.2Al₂O₃.5SiO₂), ZrSiO₄, ZrO₂, and B-eucryptite (Li₂O—Al₂O₃—SiO₂).

At least one of the second dielectric layer and barrier rib may comprise 10 to 60 mol % of Bi₂O₃, 5 to 40% of CuO, and 15 to 40 mol % of B₂O₃.

In another general aspect, a method of forming a dielectric layer on a substrate of a plasma display panel involves preparing a mixture of a first mol % of Bi₂O₃, a second mol % of CuO, and a third mol % of B₂O₃. The first mol % is greater than the second mol %, the first mol % is greater than or equal to the third mol %, and the third mol % is greater than the second mol %. The method involves melting and cooling the prepared mixture, and grinding the cooled mixture to produce a parent glass powder. The method involves forming a paste by mixing 70 to 90 wt % of the prepared parent glass powder and 10 to 30 wt % of a vehicle, the vehicle being a mixture of o to 15 wt % of a binder, 0 to 80 wt % of a solvent, and 0 to 5 wt % of a dispersant. The method involves coating a surface of the substrate with the paste. The method involves drying the coated paste and curing the coated paste at a temperature of 480° C. or lower.

Implementations may include one or more of the following features. For example, preparing the mixture may involve preparing the mixture with at least one of 0 to 10 mol % SiO₂, 0 to 30 mol % of ZnO, and 0 to 35 mol % of BaO. Preparing the mixture may further involve preparing the mixture with at least one of 0 to 10 mol % of MgO, 0 to 10 mol % of SrO, and 0 to 10 mol % of CaO, at least one of 0 to 10 mol % of Al₂O₃ and 0 to 10 mol % of La₂O₃, and 0 to 10 mol % of R₂O.

A dielectric composition for a PDP consistent with this disclosure may be free of Pb and the environmental pollution caused by Pb, largely improving cost-competitiveness of the PDP due to a relatively low unit cost, and ensuring a sufficiently low curing temperature such that thermal deformation on a substrate can be avoided in the manufacturing of the PDP.

A PDP including a dielectric layer made of a Pb-free dielectric composition consistent with this disclosure may largely improve cost-competitiveness of the PDP due to a relatively low unit cost, and ensure a sufficiently low curing temperature such that thermal deformation on a soda-lime glass substrate can be avoided in the manufacturing of the PDP. In addition, distortion between the substrate and the dielectric layer can be prevented by having a thermal expansion coefficient that matches the thermal expansion coefficient of the soda-lime glass substrate.

A PDP including barrier ribs formed using a dielectric composition consistent with this disclosure can be free from Pb and the environmental pollution caused by Pb, largely improving cost-competitiveness of the PDP due to a relatively low unit cost, and ensuring a sufficiently low curing temperature such that thermal deformation on a substrate can be avoided in the manufacturing of the PDP.

A PDP including a white dielectric layer formed using a dielectric composition consistent with this disclosure can be free from Pb and the environmental pollution caused by Pb, largely improving cost-competitiveness of the PDP due to a relatively low unit cost, and ensuring a sufficiently low curing temperature such that thermal deformation on a substrate can be avoided in the manufacturing of the PDP.

Various objectives, features and advantages will be apparent from the following description and the claims. Objectives, features and advantages may be realized and attained by the structure particularly pointed out in the written description and claims hereof as well as the appended drawings.

### BRIEF DESCRIPTION OF THE DRAWINGS

The accompanying drawings illustrate example implementations and, along with the description, serve to explain principles of this disclosure.

FIG. 1 is diagram illustrating a unit cell of an example PDP.

FIG. 2 is a flow chart illustrating an example process for forming a dielectric layer for a PDP.

### DETAILED DESCRIPTION

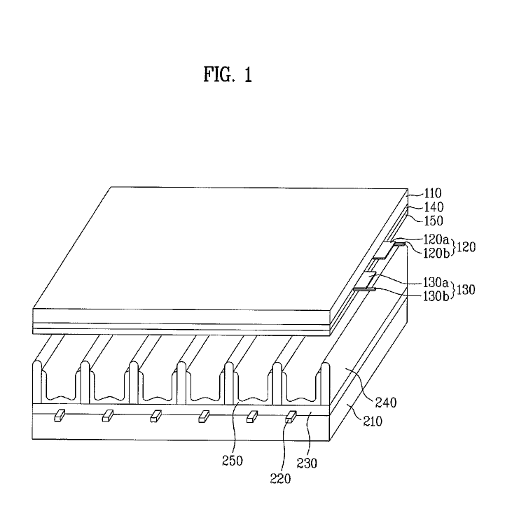

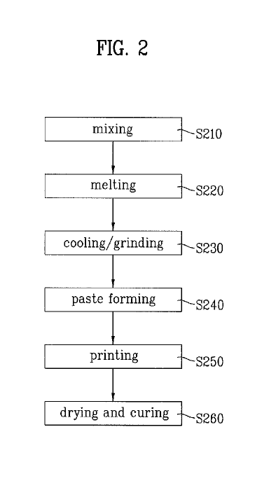

The thickness ratios of the layers shown in FIG. 1 and FIG. 2 are not actual thickness ratios. Furthermore, when an element such as a layer, film, region or substrate is referred to as being “on” another element, it can be directly on the other element or intervening elements may also be present (e.g., interposed between the elements).

As shown in FIG. 1, a PDP includes display electrodes 120 and 130 formed in pairs on the front substrate 110 while extending in one direction. A display electrode pair may include a scan electrode and a sustain electrode. Each display electrode 120 or 130 includes a transparent electrode 120a or 130a typically made of indium tin oxide (ITO), and a bus electrode 120b or 130b typically made of a metal material (e.g., silver, chromium, and/or copper). The PDP also includes a dielectric layer 140 and a protect layer 150. The layers 140 and 150 may be sequentially formed, in this order, over the overall surface of the front substrate 110, to cover the display electrodes 120 and 130.

The front substrate 110 is prepared by machining a glass for a display substrate, using milling and cleaning. The transparent electrodes 120a and 130a are formed in accordance with a photo-etching process using a sputtering process or a lift-off method using a CVD process. The bus electrodes 120b and 130b are made of silver (Ag). A black matrix may be formed on the sustain electrode pairs. The black matrix may be made of a material including a glass exhibiting a low melting point and a black pigment.

The dielectric layer 140, which is an upper dielectric layer, is formed over the front substrate 110 provided with the transparent electrodes and bus electrodes. The upper dielectric layer 140 is made of a transparent glass having a low melting point. The protect layer 150 is formed over the upper dielectric layer 140, using a magnesium oxide. The protect layer 150 functions to protect the upper dielectric layer 140 from an impact of positive (+) ions during an electrical discharge, while functioning to increase the emission of secondary electrons.

The glass composition of the upper dielectric layer 140 includes 10 to 60 mol % of Bi₂O₃ (bismuth oxide), 5 to 40 mol % of CuO (cupric oxide), and 15 to 40 mol % of B₂O₃ (boric oxide). The glass composition may further include at least one of 0 to 10 mol % of SiO₂ (silicon dioxide), 0 to 30 mol % of ZnO (zinc oxide), or 0 to 35 mol % of BaO (barium oxide) to improve fluidity. Further, the glass composition may further include at least one of 0 to 10 mol % of MgO (magnesium oxide), SrO (strontium oxide) or CaO (calcium oxide), at least one of 0 to 10 mol % of Al₂O₃ (aluminum oxide) or La₂O₃ (lanthanum oxide), and 0 to 10 mol % of R₂O. The R₂O can be at least one selected from Li₂O (lithium oxide), Na₂O (sodium oxide), or K₂O (potassium oxide).

The Bi₂O₃ added in the amount of 10 to 60 mol % serves as a glass forming agent, and functions to reduce a softening temperature, and increase a thermal expansion coefficient and a dielectric constant. Thus, the Bi₂O₃ is added in the appropriate composition ratio. The CuO added in the amount of 5 to 40 mol % functions to ensure the fluidity which may lack in the glass composition containing the Bi₂O₃ by reducing the glass transition temperature. Furthermore, the B₂O₃ added in the amount of 15 to 40 mol % is usually added as a flux to facilitate a solid-state reaction. The improvement in a glass forming ability elevates the glass transition temperature. The B₂O₃ is therefore added in the appropriate composition ratio.

The BaO added in an amount of 0 to 35 mol % is an alkaline earth oxide that serves as a network modifier. When a certain amount of BaO is added, it functions to reduce the glass transition temperature. When an excessive amount of BaO is added, however, it causes crystallization. The MgO, SrO or CaO added in an amount of 0 to 10 mol % is added to control properties, such as the glass transition temperature, thermal expansion coefficient, softening temperature, and yellowing phenomenon. The ZnO added in an amount of 0 to 30 mol % functions to reduce the thermal expansion coefficient and glass transition temperature, while increasing the glass forming ability. The ZnO also functions to absorb orange light generated by the discharge of Ne (neon) among the discharge gases injected into the inner space of the PDP, thereby preventing the degradation of a chromaticity property of the PDP.

The SiO₂ added in an amount of 0 to 10 mol % is added to prevent crystallization. The R₂O added in an amount of 0 to 10 mol % is an alkaline earth oxide that serves as a network modifier. When a certain amount of R₂O is added, it functions to reduce the glass transition temperature. When an excessive amount of R₂O is added, it causes devitrification. The R₂O is thus added in the above-mentioned appropriate composition ratio. The R₂O can be selected from Li₂O, Na₂O, or K₂O. Additionally, 0 to 10 mol % of Al₂O₃ or La₂O₃ may be further added to help mixing of the powders among the glass compositions or printing, and prevent crystallization.

The protect layer 150 is formed on the dielectric layer 140 having the above-mentioned composition using MgO.

The PDP of FIG. 1 further includes a back substrate 210. Address electrodes 220 are formed on one surface of the back substrate 210 such that they extend in a direction perpendicular to the extension direction of the display electrodes 120 and 130. A white dielectric layer 230 is also formed over the overall surface of the back substrate 210, to cover the address electrodes 220. The white dielectric layer 230 formed over the overall surface of the back substrate 210 can be prepared by using a parent glass having the same composition and composition ratio of the dielectric composition used for the dielectric layer 140 formed over the front substrate 110. The formation of the white dielectric layer 230 is achieved by laminating a layer over the back substrate 210 in accordance with a printing method or a film laminating method, and curing the laminated layer. This is because the thermal deformation of the soda-lime glass substrate that can be generated at a temperature greater than 550° C. must be prevented.

Barrier ribs 240 are formed on the white dielectric layer 230 such that each barrier rib 240 is arranged between the adjacent address electrodes 220. For the same reason as the white dielectric layer 230, the barrier ribs 240 can be prepared by using a parent glass, having the same composition and composition ratio of the dielectric composition, used for the dielectric layer 140 formed over the front substrate 110. The glass composition included in the barrier ribs 240 may further include 10 to 20 mol % of TiO2, which is a filler, and a high refractive material at the same time. Additionally, a sealing part (not shown) for sealing the front substrate 110 and back substrate (210) can make use of a material having the same composition as the above-mentioned dielectric layer or barrier ribs.

FIG. 1 shows stripe type barrier ribs 240, but other types of barrier ribs may also be used, such as a well type or a delta type.

Red (R), green (G), and blue (B) phosphor layers 250 are formed between each adjacent barrier rib 240.

Discharge cells are defined in regions where the address electrodes 220 on the back substrate 210 intersect the display electrodes 120 and 130 on the front substrate 110.

When an address voltage is applied between one address electrode 220 and one display electrode 120 or 130, an address discharge occurs in the associated cell, so that a wall voltage is generated in the cell. A sustain voltage is subsequently applied to the display electrodes 120 and 130, a sustain discharge occurs in the cell, at which the wall voltage has been generated. Vacuum ultraviolet rays generated in accordance with the sustain discharge excite the phosphors in the associated cell, so that the phosphors emit light. Thus, visible rays are emitted through the transparent front substrate 110, and an image is displayed on the PDP.

Examples of glass compositions for the dielectric layer of the PDP are described below.

Table 1 below shows specific examples (Ex. 1 to 15) of glass compositions. In Table 1, “×” represents no fluidity in the glass composition, “Δ” represents insufficient fluidity in the glass composition, and “◯” represents sufficient fluidity ensured in the glass composition.

TABLE 1

| | ZnO | B₂O₃ | BaO | MgO | A1₂O₃ | Bi₂O₃ | SiO₂ | Na₂O | CuO | Glass transition | Fluidity at |
|---|---|---|---|---|---|---|---|---|---|---|---|
| | (mol | (mol | (mol | (mol | (mol | (mol | (mol | (mol | (mol | temperature | 440 to |
| | %) | %) | %) | %) | %) | %) | %) | %) | %) | (° C.) | 480° C. |
| Ex. 1 | 16 | 34 | 9 | 0 | 3 | 33 | 0 | 0 | 5 | 377 | Δ |
| Ex. 2 | 16 | 36 | 8 | 0 | 3 | 32 | 0 | 0 | 5 | 385 | x |
| Ex. 3 | 15 | 32 | 8 | 0 | 3 | 31 | 0 | 0 | 10 | 366 | Δ |
| Ex. 4 | 15 | 30 | 6 | 0 | 3 | 30 | 0 | 0 | 15 | 380 | x |
| Ex. 5 | 14 | 28 | 7 | 0 | 3 | 28 | 0 | 0 | 20 | 381 | x |
| Ex. 6 | 13 | 27 | 7 | 0 | 3 | 27 | 0 | 5 | 19 | 369 | Δ |
| Ex. 7 | 12 | 25 | 7 | 0 | 3 | 25 | 0 | 10 | 18 | 336 | ∘ |
| Ex. 8 | 14 | 28 | 7 | 0 | 3 | 25 | 0 | 3 | 20 | 381 | x |
| Ex. 9 | 14 | 28 | 4 | 0 | 3 | 28 | 0 | 3 | 20 | 365 | Δ |
| Ex. 10 | 11 | 28 | 7 | 0 | 3 | 28 | 0 | 3 | 20 | 366 | Δ |
| Ex. 11 | 14 | 28 | 7 | 0 | 3 | 28 | 0 | 3 | 17 | 367 | Δ |
| Ex. 12 | 14 | 28 | 7 | 0 | 3 | 28 | 0 | 6 | 14 | 348 | Δ |
| Ex. 13 | 14 | 28 | 7 | 0 | 3 | 28 | 0 | 9 | 11 | 347 | ∘ |
| Ex. 14 | 14 | 28 | 7 | 0 | 3 | 28 | 0 | 0 | 17 | 386 | x |
| Ex. 15 | 0 | 29 | 9 | 5 | 4 | 53 | 0 | 0 | 0 | 351 | ∘ |

In the examples 1-15 of Table 1, the glass composition was prepared by mixing the constituent components in accordance with the compositions shown in each example, respectively. The glass composition thus prepared was melted in an electric furnace at 1250° C. The melted mixture was quickly cooled in the drying process using a twin roll. The quickly cooled mixture was crushed using a disk mill, and further grinded using a dry mill to prepare glass powder having a particle size of 1 to 1.5 μm. The glass transition temperature (Tg) of the glass powder was measured, and the result showed that a stable glass transition temperature in the range of 330 to 386° C. could be obtained. The glass transition temperature defines the heat resistance of a polymer. Thus, having a high glass transition temperature means that the polymer is not easily melted.

The fluidity was measured at a temperature in the range of 440 to 480° C., and, as a result, the glass composition prepared according to the disclosed compositions in Examples 7, 13 and 15 showed a stable fluidity. Therefore, the glass powder prepared with the above-mentioned composition and a vehicle were mixed, and the mixture was utilized in dielectric layers, barrier ribs and sealing parts of the PDP. As a result, the stability was ensured in that a low curing temperature of 480° C. or lower was possible, and, at the same time, cracks did not generate at the parts where the mixture was used.

An example method for manufacturing a PDP will now be described. First, transparent electrodes and bus electrodes are formed on a front substrate. The front substrate is prepared by milling and cleaning a glass or a soda-lime glass for a display substrate. The transparent electrodes are formed, using ITO or SnO₂, in accordance with a photo-etching method using a sputtering process or a lift-off method using a CVD process. The bus electrodes are formed, using a material such as silver (Ag), in accordance with a screen printing method or a photosensitive paste method. A black matrix may be formed on the sustain electrode pairs. The black matrix may be formed, using a low-melting-point glass and a black pigment, in accordance with a screen printing method or a photosensitive paste method.

Thereafter, a dielectric, which is an upper dielectric layer, is formed over the front substrate provided with the transparent electrodes and bus electrodes. The formation of the dielectric layer may be achieved by laminating the above mentioned dielectric material in accordance with a screen printing method or a coating method, drying and curing the laminated layer. The curing process can be performed at a curing temperature of 480° C. or lower. The dielectric material may be applied in a form of a paste.

FIG. 2 is a flow chart illustrating an example process for forming a dielectric layer for a PDP. With reference to FIG. 2, in the preparation of a dielectric material, first, 10 to 60 mol % of Bi₂O₃, 5 to 40 mol % of CuO, and 15 to 40 mol % of B₂O₃ are mixed (S210). The mixture may further include at least one of 0 to 10 mol % of SiO₂, 0 to 30 mol % of ZnO, or 0 to 35 mol % of BaO to improve fluidity. The mixture may further include at least one of 0 to 10 mol % of MgO, SrO or CaO, at least one of 0 to 10 mol % of Al₂O₃ or La₂O₃, and 0 to 10 mol % of R₂O. The R₂O is at least one selected from Li₂O, Na₂O, and K₂O.

The dielectric material mixed with the above-mentioned composition ratio is melted at high temperatures (S220). The melted mixture is quickly cooled by immersing in water having room temperature or using a dry twin roll, followed by grinding the cooled mixture using a mill (S230). If necessary, the dielectric material may be mixed with a filler and dried to prepare a parent glass powder. The filler may further include at least one substance of cordierite (2MgO.2Al₂O₃.5SiO₂), zircon (ZrSiO₄), baddeleyite (ZrO₂), or B-eucryptite (Li₂O—Al₂O₃—SiO₂) in an amount of 0 to 20 parts by weight based on the 100 parts by weight of the glass composition.

Thereafter, a paste is formed by mixing 70 to 90 wt % of the parent glass powder prepared as mentioned above and 10 to 30 wt % of a vehicle (S240). The vehicle may be a mixture of 0 to 15 wt % of a binder, 0 to 80 wt % of a solvent and 0 to 5 wt % of a dispersant to help mixing of the powders or printing. As the solvent, alcohols, glycols, propylene glycol ethers, propylene glycol acetates, ketones, BCA, xylene, terpineol, texanol, water, or the like can be used. As the dispersant, acryl-based dispersants having a high dispersing effect are mainly used. These materials are then coated (S250). For example, the paste may be applied to a surface of a substrate to coat the surface using a screen printing method or other method. Once coated, the pasted is dried and cured (S260) at a temperature of 480° C. or lower to form the upper dielectric layer.

A protect layer is then deposited over the upper dielectric layer. The formation of the protect layer may involve depositing a magnesium oxide, etc. in accordance with an electron beam deposition process, a sputtering process, or an ion plating process.

Meanwhile, address electrodes are formed on the back substrate. The back substrate is prepared by milling and cleaning a glass or a soda-lime glass for a display substrate. The address electrodes are formed, using silver (Ag), in accordance with a screen printing method, a photosensitive paste method, or a photo-etching method. The photo-etching method is carried out after completion of a sputtering process. A dielectric, which is a lower dielectric layer, is then formed over the back substrate provided with the address electrodes. The composition of the lower dielectric layer is the same as described above, and its formation is the same as that of the upper dielectric layer. It is preferred that the lower dielectric layer exhibit white, in order to achieve an enhancement in the brightness of the PDP.

Thereafter, barrier ribs are formed to separate discharge cells from one another. The material of the barrier ribs includes a parent glass and a filler. The specific composition is the same as described above, and its formation is the same as the formation of the dielectric.

A black top material is coated over the barrier rib material. The black top material includes a solvent, inorganic powder, and an additive. The inorganic powder includes glass frits and a black pigment. The layers of the barrier rib material and black top material are patterned, to form the barrier ribs and black tops.

The patterning process involves masking, light exposure, and development. That is, a mask is arranged to cover regions corresponding to the address electrodes, and a light exposure is subsequently carried out. When development and curing processes are sequentially carried out, only the light-exposed portions of the barrier rib material layer and black top material layer remain. Thus, the barrier ribs and black tops are formed. When a photoresist material is contained in the black top material, it is possible to more easily achieve the patterning of the barrier rib and black top materials. When the barrier rib and black top materials are simultaneously cured, the binding force between the parent glass of the barrier rib material and the inorganic powder of the black top material increases. In this case, accordingly, an enhancement in durability is expected.

Thereafter, phosphors are coated over the surfaces of the lower dielectric layer facing discharge spaces and the side surfaces of the barrier ribs. The coating of the phosphors is carried out such that R, G, and B phosphors are sequentially coated in each discharge cell. The coating is carried out using a screen printing method or a photosensitive paste method.

Subsequently, an upper panel is assembled to a lower panel, such that the barrier ribs are interposed between the upper and lower panels. The upper and lower panels are then sealed. The space between the upper and lower panels is then evacuated, to remove impurities from the space. A discharge gas is then injected into the space. The materials of the sealing part used for sealing the upper and lower panels are as described above.

In some implementations, the lower dielectric layer material and the barrier rib material can be laminated into a green sheet. The green sheet may have a first layer including the lower dielectric layer material and a second layer including the barrier rib material. Each material may be materials for the above-mentioned dielectric and barrier rib. The second layer is patterned into the barrier ribs, thus it contains a photoresist component.

The green sheet is formed over the back substrate formed with address electrodes, and light exposure and development is carried out on the green sheet. At this time, the second layer is patterned into the barrier rib. When the lower dielectric layer and the barrier rib are simultaneously cured at a temperature lower than 480° C., the binding force between the lower dielectric layer and the barrier rib increases. An enhancement in durability is therefore expected.

Various modifications and variations can be made in the example implementations described and shown, and other implementations are within the scope of the following claims.

What is claimed is:

1. A plasma display panel comprising:
a substrate having sustain electrodes disposed on a surface of the substrate; and
a dielectric layer disposed over the substrate and covering the sustain electrodes, the dielectric layer comprising 10 to 60 mol % of Bi₂O₃, 5 to 40 mol % of CuO, and 15 to 40 mol % of B₂O₃.

2. The panel according to claim 1, wherein the dielectric layer further comprises one of 0 to 10 mol % SiO₂, 0 to 30 mol % of ZnO, and 0 to 35 mol % of BaO.

3. The panel according to claim 1, wherein the dielectric layer further comprises one of 0 to 10 mol % of MgO, 0 to 10 mol % of SrO, and 0 to 10 mol % of CaO.

4. The panel according to claim 1, wherein the dielectric layer further comprises one of 0 to 10 mol % of Al₂O₃ and 0 to 10 mol % of La₂O₃.

5. The panel according to claim 1, wherein the dielectric layer further comprises 0 to 10 mol % of R₂O.

6. The panel according to claim 5, wherein the R₂O includes at least one of Li₂O, Na₂O and K₂O.

7. A plasma display panel comprising:
a first substrate including at least one sustain electrode pair extending in a first direction;
a first dielectric layer disposed over the sustain electrode pair;
a protect layer disposed over the first dielectric layer;
a second substrate including at least one address electrode, the at least one address electrode extending in a direction perpendicular to the first direction;
a second dielectric layer disposed on the second substrate; and
a third dielectric layer interposed between the first substrate and the second substrate,
at least one of the first, second and third dielectric layers comprising 10 to 60 mol % of Bi₂O₃, 5 to 40% of CuO, and 15 to 40 mol % of B₂O₃.

8. The panel according to claim 7, wherein at least one of the first, second and third dielectric layers further comprises one of 0 to 10 mol % SiO₂, 0 to 30 mol % of ZnO, and 0 to 35 mol % of BaO.

9. The panel according to claim 7, wherein at least one of the first, second and third dielectric layers further comprises one of 0 to 10 mol % of MgO, 0 to 10 mol % of SrO, and 0 to 10 mol % of CaO.

10. The panel according to claim 7, wherein at least one of the first, second and third dielectric layers further comprises one of 0 to 10 mol % of Al₂O₃ and 0 to 10 mol % of La₂O₃.

11. The panel according to claim 7, wherein at least one of the first, second and third dielectric layers further comprises 0 to 10 mol % of R₂O.

12. The panel according to claim 11, wherein the R₂O includes at least one of Li₂O, Na₂O and K₂O.

13. The panel according to claim 7, wherein at least one of the first and second substrates is a soda-lime glass substrate.

14. A method for manufacturing a plasma display panel comprising:
forming a first dielectric layer over a first display substrate, the first display substrate having display electrodes extending in a first direction, the first dielectric layer covering the display electrodes and comprising 10 to 60 mol % of Bi₂O₃, 5 to 40% of CuO, and 15 to 40 mol % of B₂O₃;
forming a second dielectric layer over a back substrate to cover address electrodes on the back substrate, the address electrodes extending in a direction perpendicular to the first direction; and
assembling the display substrate and the back substrate, with barrier ribs interposed between the display substrate and the back substrate, and with regions where the address electrodes intersect the display electrodes defining discharge cells.

15. The method according to claim 14, wherein forming the first dielectric layer comprises:
preparing a dielectric material comprising 10 to 60 mol % of Bi₂O₃, 5 to 40% of CuO, and 15 to 40 mol % of B₂O₃;
coating the dielectric material using one of a screen printing method, a dispensing method, and an inkjet method; and
drying and curing the dielectric material.

16. The method according to claim 15, wherein the curing is performed at a temperature of 480° C. or lower.

17. The method according to claim 15, wherein preparing the dielectric material comprises:
preparing a mixture of 10 to 60 mol % of Bi₂O₃, 5 to 40% of CuO, and 15 to 40 mol % of B₂O₃;
melting and cooling the mixture; and
forming a glass powder by grinding the mixture.

18. The method according to claim 17, wherein the dielectric material comprises 70 to 90 wt % of the glass powder and 10 to 30 wt % of vehicle.

19. The method according to claim 14, wherein the first dielectric layer further comprises a substance selected from the group consisting of cordierite (2MgO.2Al₂O₃.5SiO₂), ZrSiO₄, ZrO₂, and B-eucryptite (Li₂O—Al₂O₃—SiO₂).

20. The method according to claim 14, wherein at least one of the second dielectric layer and barrier rib comprises 10 to 60 mol % of Bi₂O₃, 5 to 40% of CuO, and to 40 mol % of B₂O₃.

21. A plasma display panel comprising:
a substrate having sustain electrodes disposed on a surface of the substrate; and
a dielectric layer disposed over the substrate to cover the sustain electrodes, the dielectric layer comprising a first mol % of Bi₂O₃, a second mol % of CuO, and a third mol % of B₂O₃, the first mol % being greater than the second mol %, the first mol % being greater than or equal to the third mol %, and the third mol % being greater than the second mol %.

22. The plasma display panel of claim 21, wherein the dielectric layer further comprises:
one of 0 to 10 mol % SiO₂, 0 to 30 mol % of ZnO, and 0 to 35 mol % of BaO;
one of 0 to 10 mol % of MgO, 0 to 10 mol % of SrO, and 0 to 10 mol % of CaO;
one of 0 to 10 mol % of Al₂O₃ and 0 to 10 mol % of La₂O₃; and
0 to 10 mol % of R₂O.

23. A method of forming a dielectric layer on a substrate of a plasma display panel, comprising:
preparing a mixture of a first mol % of Bi₂O₃, a second mol % of CuO, and a third mol % of B₂O₃, the first mol % greater than the second mol %, the first mol % greater than or equal to the third mol %, and the third mol % greater than the second mol %;
melting and cooling the prepared mixture;
grinding the cooled mixture to produce a parent glass powder;
forming a paste by mixing 70 to 90 wt % of the prepared parent glass powder and 10 to 30 wt % of a vehicle, the vehicle being a mixture of 0 to 15 wt % of a binder, 0 to 80 wt % of a solvent, and 0 to 5 wt % of a dispersant;
coating a surface of the substrate with the paste;
drying the coated paste; and
curing the coated paste at a temperature of 480° C. or lower.

24. The method of claim 23, wherein preparing the mixture comprises preparing the mixture with at least one of 0 to 10 mol % SiO₂, 0 to 30 mol % of ZnO, and 0 to 35 mol % of BaO.

25. The method of claim 23, wherein preparing the mixture comprises preparing the mixture with at least one of 0 to 10 mol % of MgO, 0 to 10 mol % of SrO, and 0 to 10 mol % of CaO, at least one of 0 to 10 mol % of Al₂O₃ and 0 to 10 mol % of La₂O₃, and 0 to 10 mol % of R₂O.
